(19) United States
(12) Patent Application Publication
(10) Pub. No.: US 2006/0035992 A1
(43) Pub. Date: Feb. 16, 2006

(54) Derivatisation of polymethacrylimides with a high molecular weight

(75) Inventors: Peter Stein, Traisa (DE); Jonas Scherbe, Muehltal (DE); Werner Geyer, Muehltal (DE); Thomas Barthel, Heppenheim (DE); Hermann Seibert, Darmstadt (DE); Leonard Maier, Rodgau (DE); Dirk Roosen, Gross-Gerau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Roehm GMBH & Co. KG, Darmstadt (DE)

(21) Appl. No.: 10/539,417

(22) PCT Filed: Oct. 18, 2003
(86) PCT No.: PCT/EP03/11542

§ 371 Date: Jun. 17, 2005

(30) Foreign Application Priority Data
Dec. 18, 2002 (DE) 10259674.3

(51) Int. Cl. B29C 44/34

(52) U.S. Cl. 521/142

(57) ABSTRACT

The invention relates to processes for preparing derivatized and partially derivatized polymethacrylimides. The properties of the material can be adjusted by appropriate selection of the derivatization, in terms of number and type.

### FIELD OF APPLICATION OF THE INVENTION

Processes for preparing derivatized and also partially derivatized polymethacrylimides, in particular high-molecular-weight polymethacrylimides, characterized in that the degree of derivatization is adjustable.

### PRIOR ART

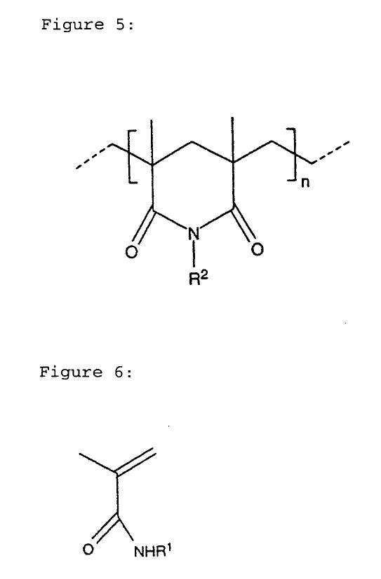

Polymethacrylimides have been known for a long time. At the two methyl groups, the ring structure of the monomer unit gives the main chain high chain stiffness (FIG. 5), and the polymethacrylimides therefore have high glass transition temperatures, extending to more than 200° C. The word “polymethacrylimide” below will be abbreviated to “PMI”.

PMI structures are accessible via a plurality of synthetic routes. One possibility, for example, is aminolysis of PMMA with the [sic] a primary amine in a suitable, high-boiling solvent (e.g. N-methyl-pyrrolidone). The resultant polymers have to be purified by reprecipitation, and this method has therefore proved successful only on a laboratory scale, where the flexibility of this method is an advantage.

The solvent-free polymer-analogous reaction of polymethyl methacrylate, abbreviated to PMMA below, with a primary amine is also known, for uses including large-scale industrial use. An advantage of this synthetic route, the industrial version of which is carried out in an extruder, is the possibility of varying the structure by using amines of various types. In principle, some of the properties may be adjusted by using mixtures. At the time of this publication, methyl-substituted poly-N-methylmethacrylimide (PMMI) has become industrially significant.

It is also possible for the PMMA chain to undergo only partial polymer-analogous reaction, as a consequence of the amount of amine used, the result being a number of commercially available products. These differ, for example, in heat distortion temperature and processing properties, due to the differing proportion of PMI structures. These products can achieve a heat distortion temperature of ˜170° C. A disadvantage of this synthetic route relates to the degree of polymerization. All of the PMMA moulding compositions used have to be fusible, in order to be capable of undergoing melting and reaction in the extruder, and they therefore have molar masses of up to about 200 000 g/mol. The main application sectors for these products are in the injection moulding sector and [lacuna] are marketed with the name PLEXIMID® (in this connection see also Die Makromolekulare Chemie [Macromolecular chemistry], 96, 227 (1966)).

High-molecular-weight, non-fusible PMI materials whose molar masses are 1 000 000 g/mol, for example, or else higher, had been possible hitherto only via a reaction of methacrylic acid and methacrylonitrile in bulk. Here, a first step produces a copolymer, which, in a second step, is converted into a PMI structure by heating. The resultant intramolecular cyclization requires hydrogen substitution at the nitrogen atom, and for that reason this route can only provide this one derivative.

The polymerization process is carried out in a cell composed, for example, of two parallel flat sheets of glass, separated by a sealing cord. The reaction mixture, generally composed of methacrylic acid, methacrylonitrile, initiator and, where appropriate, other additives, is charged to this cell, and polymerized by heating. Examples of methods of heating use water or air. After the polymerization, the cell is opened, and the resultant copolymer panel is removed.

A further heat-conditioning step at an elevated temperature converts the copolymer into the poly-methacrylimide. The copolymer can be foamed during the cyclization, by adding blowing agents to the reaction mixture.

These high-molecular-weight PMI foams are marketed with the trade name ROHACELL®, and have an excellent heat distortion temperature up to 240° C. These rigid foams are used in sandwich structures which are becoming ever more important in the transport sector, because they have low weight. A disadvantage of this synthetic route is that no alteration of the monomer unit is possible, and this causes loss of substantial degrees of freedom for influencing properties.

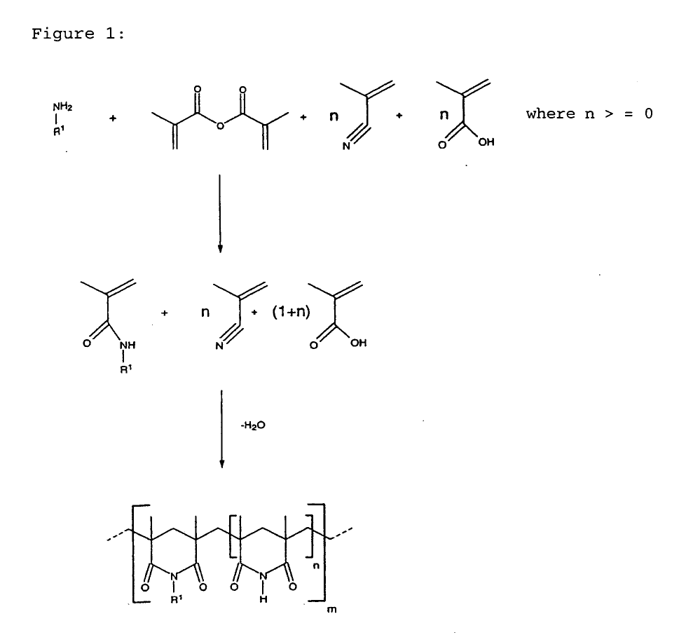

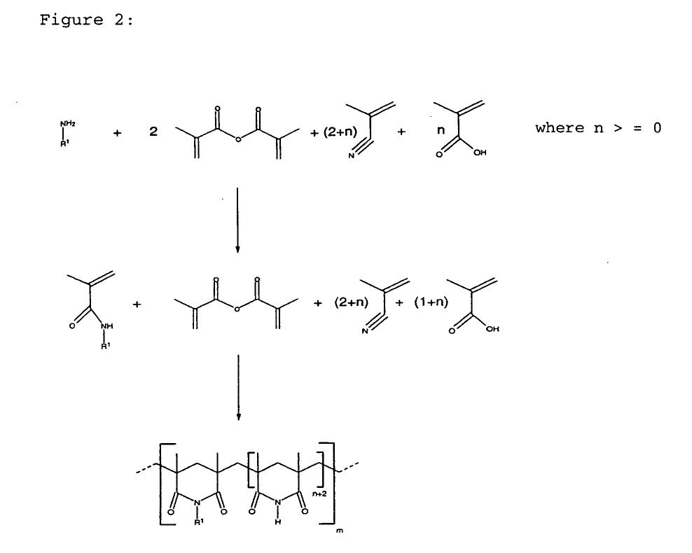

It was therefore an object of the present invention to find a way of preparing high-molecular-weight, substituted polymethacrylimides. This object can be achieved by reacting a primary amine with methacrylic anhydride, giving methacrylic acid and the corresponding methacrylamide. The resultant amide is then in solution alongside methacrylic acid. Examples of suitable solvents are mixtures of methacrylic acid and methacrylonitrile. Because these two monomers are the starting compounds for an unsubstituted polymethacrylimide, it is possible, where appropriate, to omit any purification of the methacrylamide/methacrylic acid mixture. (See FIGS. 1 and 2, where n>0.)

If the methacrylamide to be substituted does not have to be prepared in situ, but is available for the synthesis, it may be reacted with methacrylic acid or methacrylic anhydride directly.

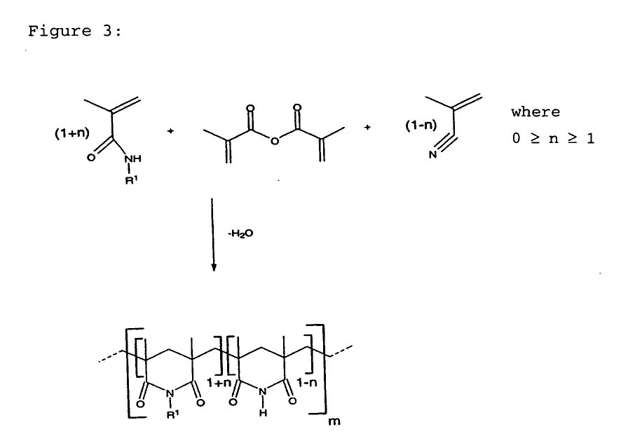

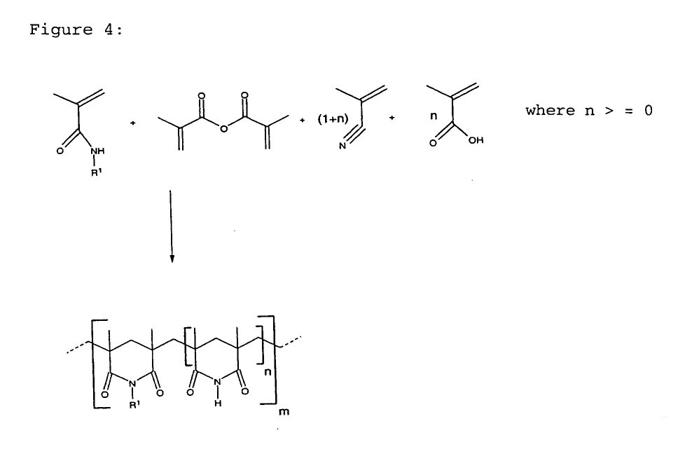

Copolymerization followed by cyclization to give the polymethacrylimide also makes it possible to achieve substitution in this way. (See FIG. 3, where 0≦n≦1, and FIG. 4, where n≧0.)

The following cases can be distinguished:

Case 1:

Full substitution: 100% degree of substitution: the degree of substitution here means the percentage proportion of the number of polymethacrylimide monomer units which do not have substitution by a hydrogen atom on the nitrogen atom. All of the other polymethacrylimide monomer units then have hydrogen substitution. This also applies for all of the other stated degrees of substitution. To achieve 100% substitution at the nitrogen atom, the methacrylamide corresponding to the amine used has to be reacted with the methacrylic acid formed. A disadvantage in this case is that the reaction described above of a primary amine with methacrylic anhydride is possible only if the amine is soluble in the anhydride and the product mixture is liquid. Otherwise, a solvent has to be used, and has to be removed prior to the polymerization. Furthermore, a molecule of water is eliminated during the cyclization reaction, and therefore a large amount of water is present in the system, and foams the polymethacrylimide. Although, therefore, this is a possible method for complete substitution, it has disadvantages. In this connection, see also FIG. 1 for n=0, where R¹ is an alkyl or aryl radical which has up to 36 carbon atoms and in which oxygen atoms, nitrogen atoms, sulphur atoms, and phosphorus atoms in the form of typical, organic functionalities, e.g. an ether function, alcohol function, acid function, ester function, amide function, imide function, phosphonic acid function, phosphonic ester, phosphinic acid function, phosphinic ester function, sulphonic acid function, sulphonic ester function, sulphinic acid function, sulphinic ester function, silicon atoms, aluminium atoms and boron atoms, or else halogens, such as fluorine, chlorine, bromine or iodine may also be present. Mention may be made of the following, but without any restriction thereto: methylamine, ethylamine, n-propylamine, 2-propylamine, n-butylamine, 2-butylamine, 3-methyl-2-butylamine, tert-butylamine, the isomers of propyl-, hexyl-, heptylamine, the isomers of octylamine, e.g. 2-ethylhexylamine, laurylamine, stearylamine, aniline, benzylamine, toluidine, alkylaniline, alkylbenzylamines, ether amines, amines of the formula H₂NR³—O—R³, ester amines, amines of the formula H₂NR³—PO(OR³)₂ or H₂NR³—CO₂—OR³, where R³ is an alkyl or aryl radical having up to 20 carbon atoms.

Case 2:

Partial substitution: from >0% to <100% degree of substitution: the procedure is as in case 1. However, the reaction of the primary amine with methacrylic anhydride is carried out in a solution composed of methacrylic acid and methacrylonitrile, where the amount of the solvent mixture has to be smaller than or equal to the amount of monomers needed for the desired degree of substitution, in order to omit any work-up step. The mixture obtained is polymerized in a cell as described above. The amount of water eliminated during the cyclization subsequently carried out falls as a function of the desired degree of substitution. In this connection, see also FIG. 1 for n>0, where R¹ is as described above. To simplify the presentation, the solvent mixture given in FIG. 1 is a stoichiometric composition of methacrylic acid and methacrylonitrile, but there is no restriction thereto. A shift in the monomer ratios is therefore possible (cf. DE 2822885, DE 3346060, DE 3826469, DE 19717483).

Case 3:

Partial substitution: from >0% to 33.3% degree of substitution: in order to avoid the elimination of water which occurs in cases 1 and 2, and the problems associated therewith, another equivalent of methacrylic anhydride may be used to scavenge the equivalent of water arising during the cyclization of amide and methacrylic acid to give the imide. A total of two equivalents of methacrylic acid therefore arise and may be scavenged using two equivalents of methacrylonitrile. The maximum achievable degree of substitution is then 33.3%, meaning that one third of all of the monomer units have non-hydrogen substitution, and not hydrogen substitution, at the nitrogen atom. An advantage in this case is that firstly there is no elimination of water during the cyclization and secondly the reaction of the primary amine can be carried out with an excess of methacrylic anhydride in two equivalents of methacrylonitrile, with no need for any work-up. This is of assistance in the case of sparingly soluble amines, and reduces the evolution of heat from the exothermic reaction. By analogy with case 2, it is also possible in case 3 for the reaction of the primary amine with methacrylic anhydride to be carried out in an additional solution composed of methacrylic acid and methacrylonitrile, the amount of the solvent mixture here having to be smaller than or equal to the amount of monomers needed for the desired degree of substitution, in order to permit omission of any work-up step. A factor which has to be considered here is that two equivalents of methacrylonitrile are consumed by the two equivalents of methacrylic acid produced. In this connection, see also FIG. 2 for n≧0, where R¹ is as described above. The procedure is demonstrated in FIG. 2 for the example of stearylamine, with no restriction thereto. To simplify the presentation, FIG. 2 also gives a stoichiometric composition of methacrylic acid and methacrylonitrile as solvent mixture, with no restriction thereto. A shift in the monomer ratios is therefore possible.

Case 4:

Full substitution: 100% degree of substitution: cases 1-3 described above are based on the procedure where the methacrylamide to be used has to be prepared in situ. However, if this methacrylamide is available in pure form for the synthesis, the procedure may be altered. Reaction of the N-methacrylamide derivative with one equivalent of methacrylic anhydride formally produces one half of an equivalent of the corresponding methacrylimide in situ. The final polymer may be obtained via copolymerization and subsequent cyclization to give the polymethacrylimide with elimination of one half of an equivalent of water (see FIG. 3 for n=1).

Case 5:

From 50% to <100 degree of substitution: the procedure is as described for case 4. Methacrylonitrile is also added to the monomer mixture and reacts with some of the methacrylic acid formed (see FIG. 3 for 0<n≦1). This is of assistance in particular when solubility problems render case 4 impossible for a particular substitution. Partial substitution can still be achieved using this method. Although it is also conceivable that a methacrylic acid/methacrylonitrile mixture could be used to reduce the degree of substitution, it is more useful to use an appropriately increased amount of methacrylic anhydride, in order to minimize the amount of water eliminated during the cyclization. However, under certain circumstances the use of a methacrylic acid/methacrylonitrile mixture is appropriate to avoid solubility problems.

Case 6:

Partial substitution: from >0% to 50% degree of substitution: the 50% degree of substitution presented here is the limiting case for n=0 described in case 5 and, respectively, FIG. 3. In this limiting case, there is complete scavenging of the water eliminated during the cyclization. Applied to FIG. 4, this like-wise corresponds to the case n=0. If a methacrylic acid/methacrylonitrile mixture is added to this mixture of substituted methacrylamide, methacrylic anhydride and methacrylonitrile, the degree of substitution can be further reduced, and at the same time there can be complete scavenging of the water formed during the cyclization.

In addition, there is the possibility of combining the cases described above, thereby still further increasing the number of possibilities and of the [sic] associated optimization potential for a particular material. By way of example, it is conceivable here to combine an amide and amine with methacrylic anhydride, methacrylic acid and methacrylonitrile. Any combination can be formally broken back down into the abovementioned cases, making any more detailed descriptions superfluous here.

To obtain the foams of the invention, a mixture composed of
(A) from 0 to 2.6 molar parts of one or more primary amines H₂NR¹, where R¹ is as described above,
   from 0 to 5.2 molar parts of one or more N-methacrylamides [sic] C₄H₆NOR¹ according to FIG. 6, where R¹ is as described above,
   from >0 to 6.5 molar parts of methacrylic anhydride,
   from 0 to 3.9 molar parts of methacrylonitrile and
   from 0 to 1.3 molar parts of methacrylic acid;
(B) from 0.3 to 2.0 molar parts of methacrylonitrile,
   from 0.7 to 2.5 molar parts of methacrylic acid and
   from 0 to 0.2 molar part of other monomers having vinyl unsaturation, where the ratio of the total of the molar parts of (B) and (A) is (B)/(A)=from 0 to 1 million;
(C) from 0.5 to 15 per cent by weight, based on the total of the weights of components (A) and (B), of a blowing agent;
(D) from 0.01 to 0.5 per cent by weight, based on the total of the weights of components (A) and (B), of one or more polymerization initiators;
(E) from 0 to 200 per cent by weight, based on the total of the weights of components (A) and (B), of conventional additives
   is polymerized to give a sheet, and then this polymer sheet is foamed at temperatures of from 150 to 250° C.

By way of example, other monomers which have vinyl unsaturation and which may be used are styrene or styrene derivatives, such as methylstyrene or chlorostyrene. Examples which may be mentioned of polymerization initiators are: azo compounds, such as 2,2′-azobis-(isobutyronitrile) or 2,2′-azobis(2,4-dimethylvalero-nitrile), redox systems, e.g. the combination of tertiary amines with peroxides, other preferred examples being peroxides (cf. in this connection by way of example H. Rauch-Puntigam, Th. Volker, “Acryl- und Methacrylverbindungen” [Acrylic and methacrylic compounds], Springer, Heidelberg, 1967 or Kirk-Othmer, Encyclopedia of Chemical Technology, Vol. 1, pp. 386 et seq., J. Wiley, New York, 1978). Examples of suitable peroxide polymerization initiators are dilauroyl peroxide, tert-butyl peroctoate, tert-butyl perisononanoate, dicyclohexyl peroxidicarbonate, dibenzoyl peroxide or 2,2-bis(tert-butylperoxy)butane. Another preferred method carries out the polymerization using a mixture of various polymerization initiators of different half-life, for example dilauroyl peroxide and 2,2-bis(tert-butylperoxy)butane, in order to keep the supply of free radicals constant over the course of the polymerization, or else at various polymerization temperatures. The amounts used of polymerization initiator are generally from 0.01 to 2% by weight, based on the monomer mixture. Examples of blowing agents which may be used for foaming, besides water, are formamide, or else an aliphatic alcohol having from 3 to 8 carbon atoms, e.g. 2-propanol or tert-butanol.

An example of an industrial benefit is the reduction in water absorption when non-polar side chains are bonded to the polymer, using the method of the invention. This can be achieved using, for example, stearylamine or laurylamine, with no restriction thereto.

Furthermore, by way of example, the incorporation of side chains with various polarities, and/or variation in the degree of substitution, can adjust the polarity of the material. An example of a purpose for which this may be utilized is to increase adhesion to a particular resin. The latter plays a major part in the technology of sandwich systems.

Non-polar aliphatic chains also act as intrinsic plasticizers, the plasticizer therefore being a covalently bonded plasticizer which cannot migrate. This method can be used, for example, to influence tensile strain at break. Polar plasticizing chains are also possible.

Another possibility is the covalent linkage of flame-retardant side chains, e.g. phosphonic acids and esters of these, without resultant restriction thereto. Advantageous factors here are that firstly no migration losses of the flame retardant can occur, and that its distribution is at the molecular level, giving it increased effectiveness.

It is also conceivable that dielectric properties can be influenced via the incorporation of aromatic systems having a particular substitution structure, for example benzoic ester. The polarizability and dipole moments of the aromatic systems here have an effect on macroscopic properties.

It is also advantageous to incorporate liquid-crystalline side chains or liquid-crystalline precursors, i.e. side chains which although they are not liquid-crystalline in the unbonded state form a liquid-crystalline phase when linked to the polymer. These phenomena are well known to the person skilled in the art, and are described in the literature. In this case, too, the dielectric properties, by way of example, are significantly affected by the liquid-crystalline phase. The liquid-crystalline phase may also be used, for example, to influence the coefficient of thermal expansion of the polymer, and also its mechanical behaviour, for example the impact strength.

Incorporation of macromolecular side chains permits, for example, the incorporation of soft phases.

### EXAMPLE 1

5 180 g of butyl methacrylamidomethanephosphonic acid were added slowly, with stirring, to a mixture of 3 360 g of methacrylic anhydride, 1 460 g of methacrylonitrile, 690 g of 2-propanol, 294 g of formamide. After the mixture had been stirred for one hour, 3 g of tert-butyl perpivalate, 2 g of tert-butyl 2-ethylperhexanoate, 7 g of tert-butyl perbenzoate, 7 g of cumyl perneodecanoate, 0.5 g of the monomethyl ether of hydroquinone and 17.0 g of PAT 1037 (available from: E. und P. Würtz GmbH & Co. KG, Industriegebiet, In der Weide 13+18, 55411 Bingen, Sponsheim.) as release agent were then added.

The mixture was stirred until homogenized and then polymerized at 38° C. for 19 h in a cell formed from two glass plates of dimensions 50×50 cm with a peripheral seal of thickness 1.85 cm. For final polymerization, the polymer was then subjected for 17.25 h to a heat-conditioning programme extending from 40° C. to 115° C. Foaming then took place for 2 h at 170° C. The resultant foam had an envelope density of 27 kg/m³. The degree of substitution of the foam was about 50%.

The resultant foam was flame-retardant by virtue of the covalently bonded, and thus molecularly distributed, phosphonic ester, and was therefore self-extinguishing.

### EXAMPLE 2

1 149 g of stearylamine were slowly added dropwise, with stirring, to a mixture of 3 734 g of methacrylic acid, 3 741 g of methacrylonitrile and 1 911 g of methacrylic anhydride. After cooling of the solution to room temperature, 295 g of tert-butanol, 126 g of formamide, 4 g of tert-butyl perpivalate, 3.5 g of tert-butyl 2-ethylperhexanoate, 10 g of tert-butyl perbenzoate, 10.3 g of cumyl perneodecanoate, 0.5 g of the monomethyl ether of hydroquinone and 16 g of PAT 1037 as release agent were then added to the mixture.

The mixture was stirred until homogenized and then polymerized at 38.5° C. for 20 h in a cell formed from two glass plates of dimensions 50×50 cm with a peripheral seal of thickness 1.85 cm. For final polymerization, the polymer was then subjected for 17.25 h to a heat-conditioning programme extending from 40° C. to 115° C. Foaming then took place for 2 h at 230° C. The resultant foam had an envelope density of 80 kg/m³. The degree of substitution of the foam was 10%.

### EXAMPLE 3

1 558 g of stearylamine were slowly added dropwise, with stirring, to a mixture of 2 653 g of methacrylic acid, 3 196 g of methacrylonitrile and 2 592 g of methacrylic anhydride. After cooling of the solution to room temperature, 295 g of tert-butanol, 126 g of formamide, 3.8 g of tert-butyl perpivalate, 3.4 g of tert-butyl 2-ethylperhexanoate, 9.4 g of tert-butyl perbenzoate, 9.7 g of cumyl perneodecanoate, 0.5 g of the monomethyl ether of hydroquinone and 16 g of PAT 1037 as release agent were then added to the mixture.

The mixture was stirred until homogenized and then polymerized at 39° C. for 19 h in a cell formed from two glass plates of dimensions 50×50 cm with a peripheral seal of thickness 1.85 cm. For final polymerization, the polymer was then subjected for 17.25 h to a heat-conditioning programme extending from 40° C. to 115° C. Foaming then took place for 2 h at 190° C. The resultant foam had an envelope density of 134 kg/m³. The degree of substitution of the foam was 15%.

### EXAMPLE 4

408 g of stearylamine were slowly added dropwise, with stirring, to a mixture of 4 844 g of methacrylic acid, 4 070 g of methacrylonitrile and 679 g of methacrylic anhydride. After cooling of the solution to room temperature, 295 g of tert-butanol, 126 g of formamide, 3.8 g of tert-butyl perpivalate, 3.4 g of tert-butyl 2-ethylperhexanoate, 9.5 g of tert-butyl perbenzoate, 9.8 g of cumyl perneodecanoate, 0.5 g of the monomethyl ether of hydroquinone and 16 g of PAT 1037 as release agent were then added to the mixture.

The mixture was stirred until homogenized and then polymerized at 38.7° C. for 19 h in a cell formed from two glass plates of dimensions 50×50 cm with a peripheral seal of thickness 1.85 cm. For final polymerization, the polymer was then subjected for 17.25 h to a heat-conditioning programme extending from 40° C. to 115° C. Foaming then took place for 2 h at 210° C. The resultant foam had an envelope density of 99 kg/m³. The degree of substitution of the foam was 3.5%.

The water absorption of the foam after 28 [lacuna] at 70° C. and 95% relative humidity was 8%, implying a 10% improvement, based on the corresponding unsubstituted specimen. A comparative specimen produced to Example 4 with a degree of substitution of 0% absorbs 9% of water under these conditions. From this it is clear that even at low degrees of substitution there is a considerable effect on the properties of the material.

### EXAMPLE 5

862 g of laurylamine were slowly added dropwise, with stirring, to a mixture of 3 802 g of methacrylic acid, 3 587 g of methacrylonitrile and 1 434 g of methacrylic anhydride. After cooling of the solution to room temperature, 295 g of tert-butanol, 126 g of formamide, 4 g of tert-butyl perpivalate, 3.5 g of tert-butyl 2-ethylperhexanoate, 10 g of tert-butyl perbenzoate, 10.3 g of cumyl perneodecanoate, 0.5 g of the monomethyl ether of hydroquinone and 16 g of PAT 1037 as release agent were then added to the mixture.

The mixture was stirred until homogenized and then polymerized at 39.5° C. for 21 h in a cell formed from two glass plates of dimensions 50×50 cm with a peripheral seal of thickness 1.85 cm. For final polymerization, the polymer was then subjected for 17.25 h to a heat-conditioning programme extending from 40° C. to 115° C. Foaming then took place for 2 h at 210° C. The resultant foam had an envelope density of 70 kg/m³. The degree of substitution of the foam was 8%.

### COMPARATIVE EXAMPLE 1

An unsubstituted foam with an envelope density of 71 kg/m³ was produced to DE 33 46 060. For this, 140 g of formamide and 135 g of water as blowing agent were added to a mixture composed of equal molar parts of 5 620 g of methacrylic acid and 4 380 g of methacrylonitrile. 10.0 g of tert-butyl perbenzoate, 4.0 g of tert-butyl perpivalate, 3.0 g of tert-butyl 2-ethylperhexanoate and 10.0 g of cumyl perneodecanoate as initiators were also admixed with the mixture. 1 000 g of dimethyl methanephosphonate (DMMP) as flame retardant were also added to the mixture. Finally, the mixture comprised 20 g of blowing agent (MoldWiz), 70 g of ZnO and 0.5 g of the monomethyl ether of hydroquinone.

This mixture was polymerized at 40° C. for 92 h in a cell formed from two glass plates of dimensions 50×50 cm with a peripheral seal of thickness 2.2 cm. For final polymerization, the polymer was then subjected for 17.25 h to a heat-conditioning programme extending from 40° C. to 115° C. Foaming then took place for 2 h at 215° C. The resultant foam had an envelope density of 71 kg/m³.

1. A composition comprising methacrylic anhydride, at least one N-methacrylamide: 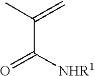
and at least one primary amine: H₂NR¹; wherein R¹ is a substituted or an unsubstituted alkyl or a substituted or an unsubstituted aryl radical comprising up to 36 carbon atoms

2. The composition of claim 1, further comprising a blowing agent comprising an aliphatic alcohol having from 3 to 8 carbon atoms, a urea, a monomethyl urea, an N,N′-dimethylurea, a formamide, water, or a combination thereof.

3. A process for producing a polymethacrylimide foam, comprising polymerizing a mixture comprising (A), (B), (C), (D), and (E) to give a polymer sheet; and foaming the polymer sheet at temperatures from 150 to 250° C.; wherein (A) comprises
from 0.7 to 1.3 molar parts of at least one primary amine:
H₂NR¹; wherein R¹ is a substituted or an unsubstituted alkyl or a substituted or an unsubstituted aryl radical comprising up to 36 carbon atoms, and
from 0.7 to 1.3 molar parts of methacrylic anhydride; wherein (B) comprises
from 0.3 to 2.0 molar parts of methacrylonitrile,
from 0.7 to 2.5 molar parts of methacrylic acid and
from 0 to 0.2 molar part of other monomers comprising vinyl unsaturation, wherein the ratio of the total of the molar parts of (B) and (A) is (B)/(A)=from 0 to 1 million; wherein (C) comprises
from 0.5 to 15 per cent by weight, based on the total of the weights of components (A) and (B), of a blowing agent; wherein (D) comprises from 0.01 to 0.5 per cent by weight, based on the total of the weights of components (A) and (B), of at least one polymerization initiator; and wherein (E) comprises
from 0 to 200 per cent by weight, based on the total of the weights of components (A) and (B), of at least one conventional additive.

4. A process for producing a polymethacrylimide foam, comprising polymerizing a mixture comprising (A), (B), (C), (D), and (E) to form a polymer sheet; and foaming the polymer sheet at temperatures from 150 to 250° C.; wherein (A) comprises
from 0.7 to 1.3 molar parts of at least one primary amine:
H₂NR¹; wherein R¹ is a substituted or an unsubstituted alkyl or a substituted or an unsubstituted aryl radical comprising up to 36 carbon atoms,
from 1.4 to 2.6 molar parts of methacrylic anhydride, and
from 1.4 to 2.6 molar parts of methacrylonitrile; wherein (B) comprises
from 0.3 to 2.0 molar parts of methacrylonitrile,
from 0.7 to 2.5 molar parts of methacrylic acid and
from 0 to 0.2 molar parts of other monomers comprising vinyl unsaturation, wherein the ratio of the total of the molar parts of (B) and (A) is (B)/(A)=from 0 to 1 million; wherein (C) comprises
from 0.5 to 15 per cent by weight, based on the total of the weights of components (A) and (B), of a blowing agent; wherein (D) comprises from 0.01 to 0.5 per cent by weight, based on the total of the weights of components (A) and (B), of at least one polymerization initiator; and wherein (E) comprises
from 0 to 200 per cent by weight, based on the total of the weights of components (A) and (B), of at least one conventional additive.

5. A process for producing a polymethacrylimide foam, comprising polymerizing a mixture comprising (A), (B), (C,. (D), and (E) to form a polymer sheet; and foaming the polymer sheet at temperatures from 150 to 250° C.: wherein (A) comprises
from 10⁻⁷ to 1.3 molar parts of at least one N-methacrylamide: 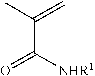
is a substituted or an unsubstituted alkyl or a substituted or an unsubstituted aryl radical comprising up to 36 carbon atoms,
from 0.7 to 1.3 molar parts of methacrylic anhydride, and
from 10⁻⁷ to 1.3 molar parts of methacrylonitrile, wherein the total of the molar parts of the methacrylonitrile and of the N-methacrylamide is from 0.7 to 1.3 molar parts; wherein (B) comprises
from 0 to 0.2 molar part of other monomers comprising vinyl unsaturation, wherein the ratio of the total of the molar parts of (B) and (A) is (B)/(A)=from 0 to 1 million; wherein (C) comprises
from 0.5 to 15 per cent by weight, based on the total of the weights of components (A) and (B), of a blowing agent; wherein (D) comprises from 0.01 to 0.5 per cent by weight, based on the total of the weights of components (A) and (B), of at least one polymerization initiator; and wherein (E) comprises
from 0 to 200 per cent by weight, based on the total of the weights of components (A) and (B), of at least one conventional additive.

6. A process for producing a polymethacrylimide foam, comprising polymerizing a mixture comprising (A), (B), (C), (D), and (E) to form a polymerized sheet; and foaming the polymerized sheet at temperatures from 150 to 250° C.; wherein (A) comprises
from 0.7 to 1.3 molar parts of at least one N-methacrylamide: 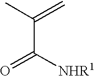
wherein R¹ is a substituted or an unsubstituted alkyl or a substituted or an unsubstituted aryl radical comprising up to 36 carbon atoms,
from 0.7 to 1.3 molar parts of methacrylic anhydride, and
from 0.7 to 1.3 molar parts of methacrylonitrile;
wherein (B) comprises
from 0.3 to 2.0 molar parts of methacrylonitrile,
from 0.7 to 2.5 molar parts of methacrylic acid, and
from 0 to 0.2 molar part of other monomers comprising vinyl unsaturation, wherein the ratio of the total of the molar parts of (B) and (A) is (B)/(A)=from 0 to 1 million;
wherein (C) comprises
from 0.5 to 15 per cent by weight, based on the total of the weights of components (A) and (B), of a blowing agent;
wherein (D) comprises
from 0.01 to 0.5 per cent by weight, based on the total of the weights of components (A) and (B), of at least one polymerization initiator; and wherein (E) comprises
from 0 to 200 per cent by weight, based on the total of the weights of components (A) and (B), of at least one conventional additive.

7. A process for producing a polymethacrylimide foam, comprising polymerizing a mixture comprising (A), (B), (C), (D) and (E) to form a polymer sheet; and foaming the polymer sheet at temperatures from 150 to 250° C.; wherein (A) comprises
from 0 to 2.6 molar parts of at least one primary amine:
H₂NR¹; wherein R¹ is a substituted or an unsubstituted alkyl or a substituted or an unsubstituted aryl radical comprising up to 36 carbon atoms,
from 0 to 5.2 molar parts of at least one N-methacrylamide: 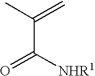
wherein R¹ is a substituted or an unsubstituted alkyl or a substituted or an unsubstituted arm radical comprising up to 36 carbon atoms,
from >0 to 6.5 molar parts of methacrylic anhydride,
from 0 to 3.9 molar parts of methacrylonitrile and
from 0 to 1.3 molar parts of methacrylic acid;
wherein (B) comprises
from 0.3 to 2.0 molar parts of methacrylonitrile,
from 0.7 to 2.5 molar parts of methacrylic acids, and
from 0 to 0.2 molar part of other monomers comprising vinyl unsaturation, wherein the ratio of the total of the molar parts of (B) and (A) is (B)/(A)=from 0 to 1 million;
wherein (C) comprises
from 0.5 to 15 per cent by weight, based on the total of the weights of components (A) and (B), a blowing agent;
wherein (D) comprises
from 0.01 to 0.5 per cent by weight, based on the total of the weights of components (A) and (B), of at least one polymerization initiator; and wherein (E) comprises
from 0 to 200 per cent by weight, based on the total of the weights of components (A) and (B), of at least one conventional additive.

8. The process of claim 3, wherein the blowing agent comprises an aliphatic alcohol having from 3 to 8 carbon atoms, a urea, a monomethyl urea, an N,N′-dimethylurea, a formamide, water, or a combination thereof.

9-13. (canceled)

14. A poly(meth)acrylimide foam produced by the process of claim 3.

15. A laminate comprising the poly(meth)acrylimide foam of claim 14.

16. An automobile comprising the poly(meth)acrylimide foam of claim 14.

17. A rail vehicle comprising the poly(meth)acrylimide foam of claim 14.

18. A watercraft comprising the poly(meth)acrylimide foam of claim 14.

19. A rotor comprising the poly(meth)acrylimide foam of claim 14.

20. The process of claim 4, wherein the blowing agent comprises an aliphatic alcohol having from 3 to 8 carbon atoms, a urea, a monomethyl urea, an N,N′-dimethylurea, a formamide, water, or a combination thereof.

21. The process of claim 5, wherein the blowing agent comprises an aliphatic alcohol having from 3 to 8 carbon atoms, a urea, a monomethyl urea, an N,N′-dimethylurea, a formamide, water, or a combination thereof.

22. The process of claim 6, wherein the blowing agent comprises an aliphatic alcohol having from 3 to 8 carbon atoms, a urea, a monomethyl urea, an N,N′-dimethylurea, a formamide, water, or a combination thereof.

23. The process of claim 7, wherein the blowing agent comprises an aliphatic alcohol having from 3 to 8 carbon atoms, a urea, a monomethyl urea, an N,N′-dimethylurea, a formamide, water, or a combination thereof.

24. The composition of claim 1, wherein R¹ further comprises oxygen atoms, nitrogen atoms, sulphur atoms, phosphorus atoms, silicon atoms, aluminium atoms, boron atoms, fluorine atoms, chlorine atoms, bromine atoms, iodine atoms, or a combination thereof.

25. The composition of claim 1, wherein R¹ is a methyl group, an ethyl group, an n-propyl group, a 2-propyl group, an n-butyl group, a 2-butyl group, a 3-methyl-2 butyl group, a tert-butyl group, an isomer of the propyl, hexyl, and heptyl groups, an isomer of the octyl group, a 2-ethylhexyl group, a lauryl group, a stearyl group, a phenyl group, a benzyl group, an alkylphenyl group, an alkylbenzyl group, or an R³ PO(OR³)₂ group, wherein R³ is an alkyl or aryl radical having up to 20 carbon atoms.
